(19) United States
(12) Patent Application Publication
(10) Pub. No.: US 2011/0140001 A1
(43) Pub. Date: Jun. 16, 2011

(54) HIGH THROUGHPUT FIBER OPTICAL ASSEMBLY FOR FLUORESCENCE SPECTROMETRY

(75) Inventors: Martin S. Piltch, Los Alamos, NM (US); Perry Clayton Gray, Fairfax, VA (US)

(73) Assignee: LOS ALAMOS NATIONAL SECURITY, LLC, Los Alamos, NM (US)

(21) Appl. No.: 12/966,665

(22) Filed: Dec. 13, 2010

Related U.S. Application Data
(60) Provisional application No. 61/286,684, filed on Dec. 15, 2009.

(51) Int. Cl. G01J 1/58

(52) U.S. Cl. 250/458.1; 250/227.11

(57) ABSTRACT

System for high-throughput detection of the presence of an analyte of interest in a sample, said system comprising a multi-well plate sample container; an automated means for successively transporting samples from the multi-well plate sample container to a transparent capillary contained within a sample holder; an excitation source in optical communication with the sample, wherein radiation from the excitation source is directed along the length of the capillary, and wherein the radiation induces a signal which is emitted from the sample; and, at least one linear array comprising: a proximal end disposed in proximity to the sample holder and a single end port distal from the proximal end; a plurality of optical fibers extending from the proximal end to the end port and having a first end and a second end, wherein the first ends of the individual optical fibers are arranged substantially parallel and adjacent to one another, and wherein the second ends of the optical fibers form a non-linearly arranged bundle, and wherein the plurality of optical fibers transmits the fluorescent signal from the proximal end to the end port; and an end port assembly optically coupled to the end port, the end port assembly comprising a single photo-detector, wherein the photo-detector detects the fluorescent signal and converts the fluorescent signal into an electrical signal.

### REFERENCE TO PRIOR APPLICATION

This application claims the benefit of priority to U.S. Patent Application 61/286,684, filed Dec. 15, 2009, and incorporated herein in its entirety.

### STATEMENT REGARDING FEDERAL RIGHTS

This invention was made with government support under Contract No. DE-AC52-06 NA 25396, awarded by the U.S. Department of Energy. The government has certain rights in the invention.

### FIELD OF THE INVENTION

The present invention relates to a system for rapid, high throughput detection the presence of trace quantities of an analyte of interest in a sample.

### BACKGROUND OF INVENTION

The present invention relates generally to an apparatus and method for improved optical geometry for enhancement of spectroscopic detection of analytes in a sample. More particularly, the invention relates to an apparatus and method for ultrasensitive detection of prions and other low-level analytes.

A conventional method of performing laser induced fluorescence as well as other types of spectroscopic measurements such as infrared, UV-vis, phosphorescence, etc. is to use a small transparent cuvette to contain the sample to be analyzed. A standard cuvette has dimensions of about 1 cm×1 cm and is about 3.5 cm in height and sealed at the bottom. The cuvette is usually made of fused quartz or optical quality borosilicate glass, is optically polished and may have an antireflective coating. The cuvette is filled from an upper, open end that may be equipped with a stopper.

To perform a measurement, the cuvette is filled with the liquid to be investigated and then illuminated with a laser focused through one of the cuvette's faces. A lens is placed in line with one of the faces of the cuvette located at ninety degrees from the input window to collect the laser-induced fluorescence light, so as to reduce interference from the laser itself and from other noise. Only a small volume of the cuvette is actually illuminated by the laser and produces a detectable spectroscopic emission. The output signal is significantly reduced by the fact that the lens picks up only approximately ten percent of the spectroscopic emission due to solid angle considerations. This general system has been used for at least seventy-five years.

Previous developments described in U.S. patent application Ser. No. 11/634,546, filed on Dec. 7, 2006, and in U.S. Provisional Patent Application 61/211,264, filed on Mar. 25, 2009, increased the amount of output signal and may result in detection of attomolar quantities of fluorescent compounds. The present invention describes instrumentation having similar detection capabilities with significantly enhanced throughput.

### SUMMARY OF INVENTION

The following describe a non-limiting embodiment of the present invention.

According to a first embodiment of the present invention, a system for high-throughput detection of the presence of an analyte of interest in a sample is provided, a system for high-throughput detection of the presence of an analyte of interest in a sample, said system comprising a multi-well plate sample container; an automated means for successively transporting samples from the multi-well plate sample container to a transparent capillary contained within a sample holder; an excitation source in optical communication with the sample, wherein radiation from the excitation source is directed along the length of the capillary, and wherein the radiation induces a signal which is emitted from the sample; and, at least one linear array comprising: a proximal end disposed in proximity to the sample holder and a single end port distal from the proximal end; a plurality of optical fibers extending from the proximal end to the end port and having a first end and a second end, wherein the first ends of the individual optical fibers are arranged substantially parallel and adjacent to one another, and wherein the second ends of the optical fibers form a non-linearly arranged bundle, and wherein the plurality of optical fibers transmits the fluorescent signal from the proximal end to the end port; and an end port assembly optically coupled to the end port, the end port assembly comprising a single photo-detector, wherein the photo-detector detects the fluorescent signal and converts the fluorescent signal into an electrical signal.

### BRIEF DESCRIPTION OF THE DRAWINGS

FIG. 1 is a schematic representation showing four linear arrays (101) extending from a sample container (102).

FIG. 2 is a schematic representation showing a side view of one embodiment of an end port assembly of the present invention.

FIG. 3 is a schematic representation of one embodiment of a sample container of the present invention.

FIG. 4 is a schematic representation of the sample container of FIG. 3, as viewed from one side.

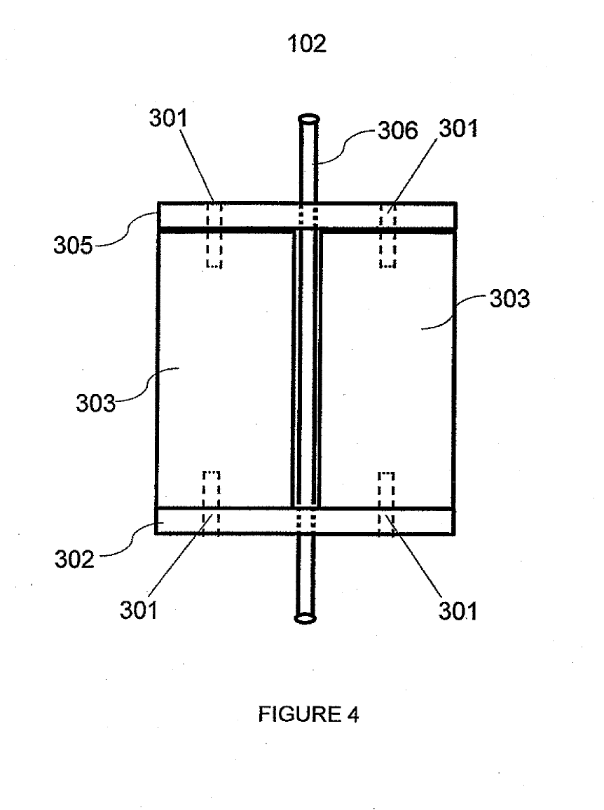

FIG. 5 is a schematic representation of the sample container of FIG. 3, as viewed from the top.

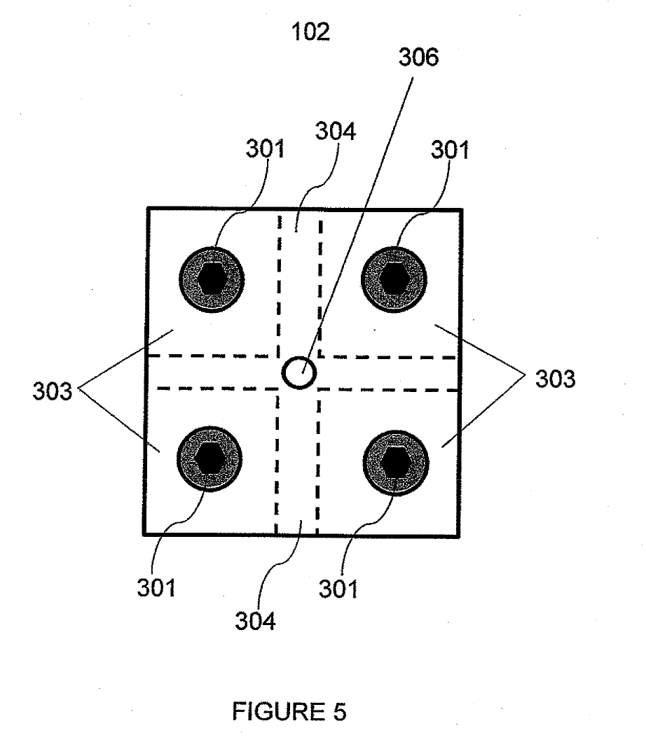

FIG. 6 is a schematic representation of the present invention, which comprises a multi-well plate sample container.

FIG. 7 depicts two linear arrays of the present invention radially disposed in proximity to a sample holder.

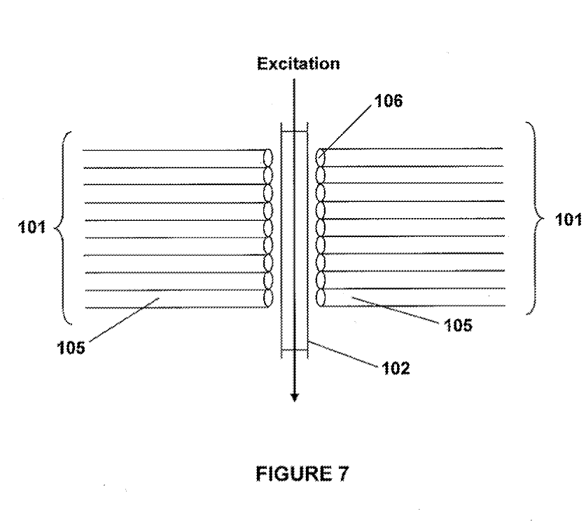

### DETAILED DESCRIPTION

The present invention describes a system for rapid, high throughput detection of as little as attomole quantities of an analyte of interest in a sample. The analyte of interest may be biological or chemical in nature, and by way of example only may include chemical moieties (toxins, metabolites, drugs and drug residues), peptides, proteins, cellular components, viruses, and combinations thereof. The analyte of interest may be in either a fluid or a supporting media such as, for example, a gel. In one embodiment, the analyte of interest is a prion, a conformationally altered form (PrP^{Sc}) of cellular prion protein (PrP^{C}), which has distinct physiochemical and biochemical properties such as aggregation, insolubility, protease digestion resistance, and a β-sheet-rich secondary structure. Herein, “prion” is understood to mean the abnormal isoform (e.g., PrP^{s}') of a proteinaceous, infectious agent implicated in causing transmissible spongiform encephalopathies (TSE's) or prion diseases, understood herein to include but are not limited to, the human diseases Creutzfeldt-Jakob disease (CJD), Gerstmann-StrSussler-Scheinker syndrome (GSS), fatal familial insomnia (FFI), and kuru, as well as the animal forms of the disease: bovine spongiform encephalopathy (BSE, commonly known as mad cow disease), chronic wasting disease (CWD) (in elk and deer), and scrapie (in sheep). It is to be understood that “proteinaceous” means that the prion may comprise proteins as well as other biochemical entities, and thus is not intended to imply that the prion is comprised solely of protein.

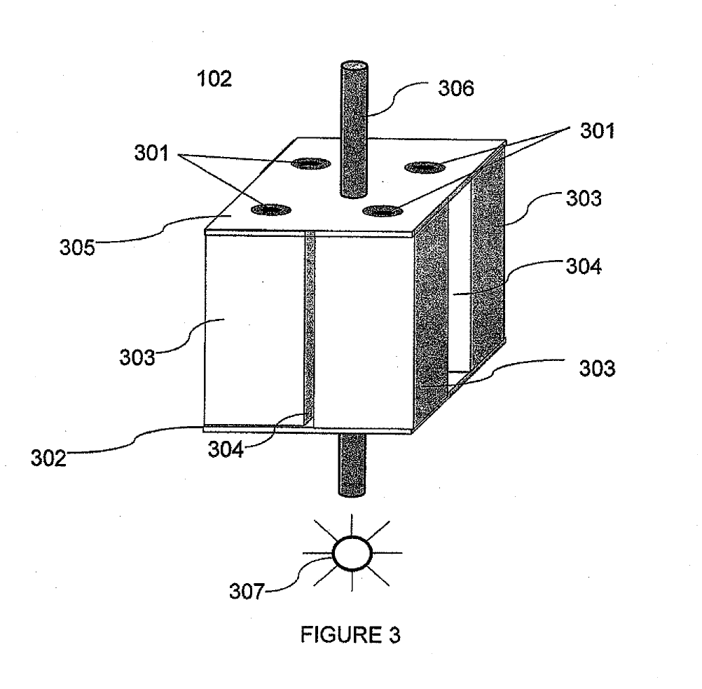

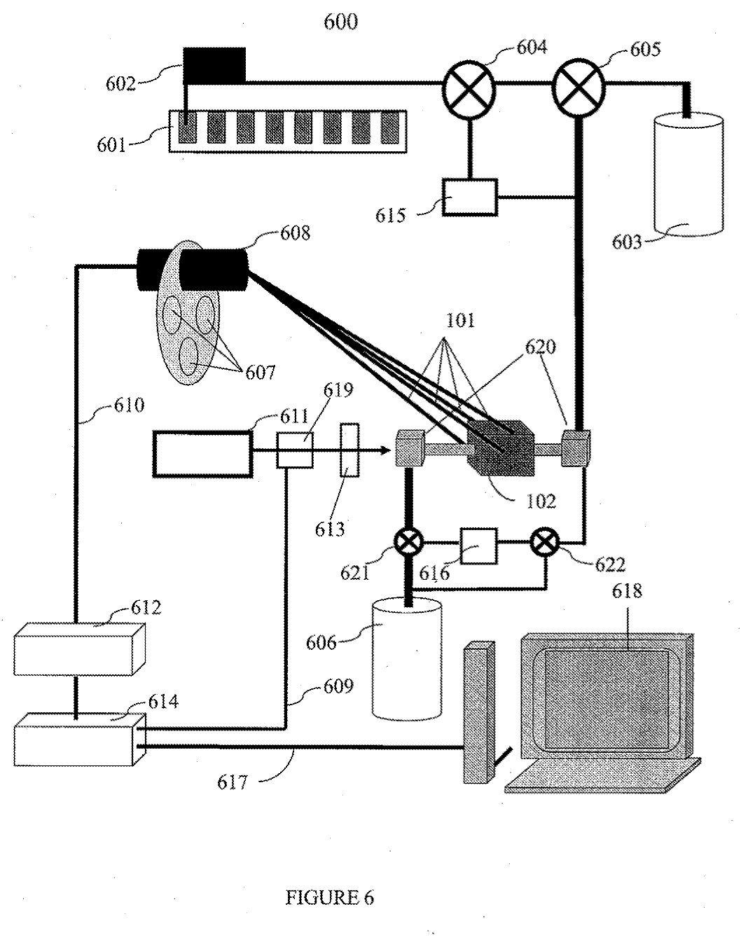

In one embodiment, the sample is irradiated by an excitation source 611 (FIG. 6) in optical communication with the sample 307 (FIG. 3). The radiation from the excitation source may be directed along the length of the sample. The excitation source may include, but is not limited to, a laser, a flash lamp, an arc lamp, a light emitting diode, or the like. Preferably, the excitation source is a laser. One non-limiting example of a suitable laser is a 532 nm, frequency doubled Nd:YAG laser. Irradiation of the sample causes the sample to emit a signal. The signal may be selected from the group consisting of fluorescence, phosphorescence, ultraviolet radiation, visible radiation, infrared radiation, Raman scattering, and combinations thereof. In one embodiment, the signal is a fluorescence signal. The emitted signal may be correlated to the concentration of the analyte in the sample by methods that would be readily apparent to one of skill in the art.

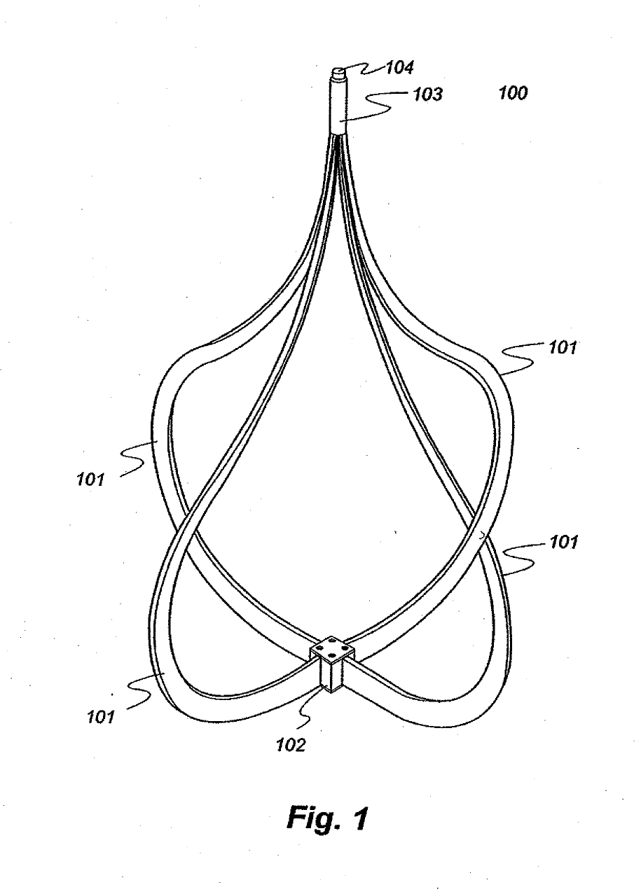

FIG. 1 depicts one embodiment of the system 100 of the present invention. In this embodiment, four linear arrays 101 extend from a sample holder 102, which houses an elongated, transparent sample container, to an end port 103. The distal end of the endport 104 is inserted into an end port assembly 200. The linear arrays 101 comprise a plurality of optical fibers having a first end and a second end, the plurality of optical fibers optionally surrounded by a protective and/or insulating sheath. The optical fibers are linearly arranged, meaning that they are substantially parallel to one another so as to form an elongated row of fibers. “Linear array,” as used herein, is thus understood to mean that the first ends of the individual fibers are adjacent and substantially parallel to one another, so as to form a substantially linear arrangement, capable of extending along the length of the capillary (see FIG. 6). The number of fibers may vary, and in one embodiment is from about 10 to about 100, alternatively is from about 25 to about 75, and alternatively is about 50. The number of linear arrays in a system may vary. The maximum number of linear arrays is dependent upon the size of the sample holder in that the sample holder must be large enough to afford sufficient space for the first ends of the optical fibers to be in proximity to a sample container. Herein, “proximity” is understood to mean a distance of from about 1 mm to about 1 cm between the first ends and the sample holder. In one embodiment, the number of linear arrays is from 2 to 10, alternatively is from about 4 to 6, and alternatively is 4. In one embodiment, the linear arrays are radially disposed about the sample holder, wherein “radially disposed” is understood to mean that the individual arrays (which extend along the length of the sample holder and remain substantially parallel to one another), extend outward from, and are substantially perpendicular to, the sample holder, similar to elongated spokes on a wheel. “Radially disposed” is not understood to mean that a single array is placed around the circumference of the sample holder. The adjacent linear arrays may be oriented substantially equidistantly from one another and surrounding the sample holder, as shown in FIG. 1. For example, when the number of linear arrays is two, the linear arrays may be placed on opposing sides of the sample holder. When the number of linear arrays is three, the adjacent linear arrays may be oriented at 120 degree angles with respect to each other; when the number is four, the adjacent linear arrays may be oriented at 90 degree angles with respect to each other, etc.

The length of the optical fibers within a linear array may vary widely and is dependent upon the number and nature of the optical fibers. The length must be sufficient to allow bundling of the optical fibers from each linear array without compromising the integrity of the optical fibers. In principle, there is no upper limit on the length of the optical fibers, which would allow for a sample to be located remotely from the diagnostic equipment used to analyze the sample.

In one embodiment, the second ends of the optical fibers are bundled together to form a single end port (see FIG. 1, 103). In other words, a given length of the second ends of the fibers from one or more linear arrays are arranged in a non-linear manner (e.g., in a round or oblong shape) to form a single bundle. If the second ends of multiple linear arrays are bundled, preferably the second ends of the fibers from each linear array are randomly interspersed within the bundle. The bundle comprising the second ends of the optical fibers is then placed in contact, or inserted into, an endport assembly 200. In one embodiment, the endport assembly 200 comprises a single detector. The plurality of optical fibers receives the signal emitted from the analyte of interest and transmits the signal from the first ends of the fibers to the end port comprising the second ends of the fibers. The fibers have a high numerical aperture (NA), which correlates to sine θ/2, where θ is the angle of accepted incident light (optical acceptance angle). In the present invention, the NA may range from about 0.20 to about 0.25 and the optical acceptance angle of from about 20 degrees to about 45 degrees. The optical acceptance angle is chosen such that substantially all of the emitted signal may be intercepted by the plurality of fibers. This ensures optimum collection efficiency of the signal from dilute analytes, such as PrP^{SC}.

In one embodiment, the optical fibers comprise fused silica. The fibers may have a diameter of from about 50 micrometers to about 400 micrometers. The bundling of the optical fibers from each linear array offers several advantages. Rather than separate detectors for each linear array being required, a single detector may be used. For a system comprising four linear arrays, this results in a detection area having one-quarter the size of four individual detectors. The background noise thus is dramatically decreased, which in turn increases the signal to noise ratio and thus lowers the limit of detection. In one embodiment, the size of the detector is from about 0.5 mm×0.5 mm to about 1 mm×1 mm. The limit of detection of the system of the present invention is at least 0.1 attomole of analyte, alternatively is at least 200 attomole, alternatively is from about 0.1 attomole to about 1.0 micromole, alternatively is from about 0.1 attomole to about 1 nanomole, and alternatively is from about 0.4 to about 1.0 attomole of analyte. Alternatively, the limit of detection of the system is at least 0.1 attogram of analyte, and alternatively is at least 10 attogram of analyte.

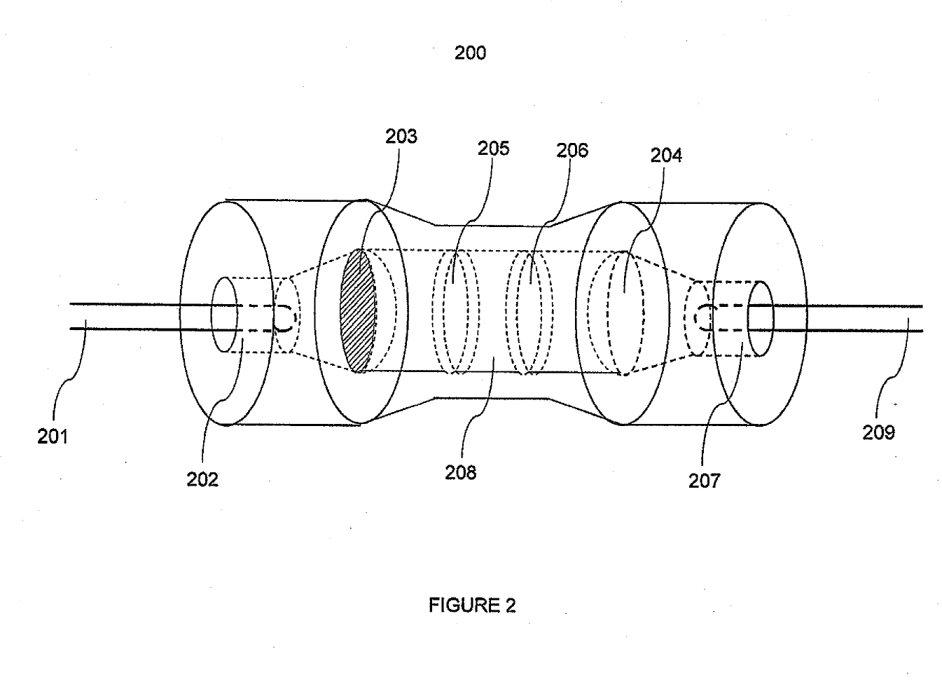

FIG. 2 depicts one embodiment of an endport assembly of the present invention. The distal end of the single endport 104 comprising the bundled optical fibers is inserted into the entrance 202 of endport assembly 200. The signal is transmitted by the optical fibers through the endport assembly 200 to the exit 207, and is then transmitted to outgoing optical fiber 208 which in turn is in contact with a detector. Outgoing optical fiber 208 may have a diameter of from about 300 microns to about 500 microns, and preferably is about 400 microns. Therefore, the end port assembly optically couples the single end port to the detector. The endport assembly may comprise a first lens 203, which serves to collimate the incident signal. The endport assembly further may comprise a second lens 204, which serves to focus the outgoing signal to a NA suitable for outgoing optical fiber 208. The endport assembly further may comprise at least one notch filter 205 and at least one bandpass filter 206.

Non-limiting examples of suitable detectors include photo-diode detectors, photo-multipliers, charge-coupled devices, a photon-counting apparatus, optical spectrometers, and any combination thereof.

FIG. 3 depicts one embodiment of a suitable sample holder 102 of the present invention. Spacers 303 are positioned such as to provide a space for an elongated, transparent container 306 to pass through the sample holder 300. In one embodiment, the sample holder 300 is a capillary, and may be made of glass, quartz, or any other suitable material that would be known to one of skill in the art. By way of example only, the capillary may hold 100 microliters of fluid. Spacers 303 further are positioned to provide a slot 304, or space, for the first ends of the optical fibers to surround and be in close proximity to the transparent container. Spacers 302 are held in place by top end plate 305 and bottom end plate 302, both of which are attached to the spacers 303 by a means for fastening 301, such as a screw.

FIG. 6 depicts an alternative embodiment of a system of the present invention 600, which is capable of rapid, high-throughput sample analysis. In this embodiment, the sample may be transferred from a multi-well plate sample container 601, such as a 96-well plate capable of containing the sample of interest, by a robotic sampler 602. In one embodiment, a computer-controlled, indexed suction device transfers the sample from an individual well in the multi-well plate 601 into a sample holder 102, which contains one or more transparent sample containers, or capillaries, 306 (not shown) having a volume of from about 100 μl to about 200 μl. Alternatively, the sample may be transferred via diverter valve 604 to a primary plenum 615, which may serve as a secondary storage area for the sample prior to analysis. Concurrently, all electronic components are temperature stabilized and monitored for proper operation and input noise level. The sample holder may be as depicted in FIG. 3 (102), or may be capable of comprising a plurality of sample containers. Optionally, a suitable amount of solvent may be added to a sample container. The solvent flows from solvent reservoir 603, via diverter valve 605 to the sample holder. On either side of the sample holder, and in fluid connection therewith, are two reservoirs 620, which facilitate sample loading and may contain any sample overflow. After analysis, the sample is transferred, e.g., by computer-controlled suction or pressure, from sample holder 102 to a secondary plenum 616 via diverter valves 621 and 622, which would allow subsequent repeat analyses, or flow to a fluid waste reservoir 606. Spectroscopic grade solvent is then transferred from solvent reservoir 603 to the sample holder 102 until the monitored fluorescent signal is observed to have returned to the system's intrinsic noise level.

Excitation source 611 emits a signal, such as laser radiation, which illuminates the sample in the sample holder 102. Prior to illuminating the sample, the signal passes through an optical chopper 619. The optical chopper 619 in turn creates a reference signal 609, which is transmitted to lock-in amplifier 614. Situated between the chopper 619 and the sample holder 102 is an optical shutter 613. Optical shutter 613 is opened during analysis, which permits excitation energy to illuminate the sample within the sample holder 102. Upon illumination, the sample emits one or more fluorescent signals, which are transmitted to a plurality of linear arrays 101 comprising a plurality of optical fibers, as depicted in FIG. 1, which extend from a sample holder 102. In one embodiment, the number of linear arrays is four. The linear arrays 101 optionally may be surrounded by a protective and/or insulating sheath.

In one embodiment, the optical fibers from the linear arrays 101 are bundled, and the bundled fibers are inserted into the entrance of optical assembly 608, which comprises optical lenses, one or more filters 607 and a single detector. When more than one filter is present, the filters may be attached to a means for changing the filters, such as a wheel (depicted in FIG. 6). Alternatively, each linear array 101 may be attached to an individual filter and detector. The substantially simultaneous acquisition of multiple fluorescent signals constitutes multiplexed operation of the system 600. The detector(s) generate(s) a detected signal 610, which is transmitted to transconductance preamplifier 612, which in turn is connected to lock-in amplifier 614. From the lock-in amplifier 614, output signal 617 is transmitted to computer 618. The duration of analysis of a single sample comprises from about 1 min. to about 5 min., and alternatively is about 3 min.

Another advantage of the system of the present invention is that no external power source is required, other than to power a laser (which may be remotely located) to collect and detect the signal emitted from the analyte of interest. This simplifies the system, increases portability and thus the range of applications, including remote analyses. In addition, the absence of an external power source significantly further reduces the amount of background noise that must be overcome, which in turn contributes to a lower limit of detection.

The emitted fluorescence signal that is captured is converted to an electrical signal by photo-detector and transmitted to an analyzer (not shown), which receives the electrical signal and analyses the sample for the presence of the analyte. Examples of analyzers would be well-understood by those of skill in the art. The analyzer may include a lock-in amplifier, which enables phase sensitive detection of the electrical signal, or any other means known in the art for analyzing electric signals generated by the different types of photo-detectors described herein.

In all embodiments of the present invention, all percentages are by weight of the total composition, unless specifically stated otherwise. All ratios are weight ratios, unless specifically stated otherwise. All ranges are inclusive and combinable. All numerical amounts are understood to be modified by the word “about” unless otherwise specifically indicated.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

Whereas particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for high-throughput detection of the presence of an analyte of interest in a sample, said system comprising:
a) a multi-well plate sample container;
b) an automated means for successively transporting samples from the multi-well plate sample container to a transparent capillary contained within a sample holder;
c) an excitation source in optical communication with the sample, wherein radiation from the excitation source is directed along the length of the capillary, and wherein the radiation induces a signal which is emitted from the sample; and,
d) at least one linear array comprising:
i. a proximal end disposed in proximity to the sample holder and an end port distal from the proximal end;
ii. a plurality of optical fibers extending from the proximal end to a single end port and having a first end and a second end, wherein the first ends of the individual optical fibers are arranged substantially parallel and adjacent to one another, and wherein the second ends of the optical fibers form a non-linearly arranged bundle, and wherein the plurality of optical fibers transmits the fluorescent signal from the proximal end to the end port; and
iii. an end port assembly optically coupled to the end port, the end port assembly comprising a single photo-detector, wherein the photo-detector detects the fluorescent signal and converts the fluorescent signal into an electrical signal.
e) an end port assembly optically coupled to the single end port and to a detector.

2. The system of claim 1, wherein the end port assembly comprises an array of filters, said array comprising at least two different filters.

3. The system of claim 1, wherein the filters may be interchangeably placed between the single end port and the detector.

4. The system according to claim 1, farther comprising an analyzer electrically coupled to the detector, wherein the analyzer receives an electrical signal from the detector and analyzes the sample for the presence of the analyte based upon the electrical signal.

5. The system according to claim 1, wherein the linear array comprises from about 10 to about 100 optical fibers.

6. The system according claim 1, wherein the system comprises at least two linear arrays.

7. The system according to claim 6, wherein the linear arrays are disposed about the sample holder radially and substantially equidistantly with respect to each other.

8. The system according to claim 1, wherein the photo-detector is a photo-diode or a photo-multiplier.

9. The system according to claim 1, wherein the system has a limit of detection of at least 200 attomoles.

10. The system of claim 1, wherein the sample holder has a volume of from about 100 microliters to about 200 microliters.
